(19) United States
(12) Patent Application Publication
(10) Pub. No.: US 2014/0152108 A1
(43) Pub. Date: Jun. 5, 2014

(54) DISCHARGE CONTROL SYSTEM AND DISCHARGE DEVICE

(71) Applicant: Satoaki TAKABATAKE, Aichi-gun (JP)

(72) Inventor: Satoaki TAKABATAKE, Aichi-gun (JP)

(73) Assignee: TOYOTA JIDOSHA KABUSHIKI KAISHA, Toyota-shi (JP)

(21) Appl. No.: 14/068,709

(22) Filed: Oct. 31, 2013

(30) Foreign Application Priority Data
Nov. 30, 2012 (JP) 2012-263287

(51) Int. Cl. H02J 7/00

(52) U.S. Cl. CPC H02J 7/00
USPC 307/64

(57) ABSTRACT

A discharge control system includes: a command unit configured to issue a discharge command to discharge electric charge stored in a capacitor and a discharge stop command to stop discharging the electric charge; a first power supply configured to supply electric power to the command unit; a discharge circuit unit configured to discharge the electric charge in accordance with the discharge command and stop discharging the electric charge in accordance with the discharge stop command; a power supply monitoring unit configured to monitor a state of the first power supply; and a discharge stop control unit configured to when the discharge circuit unit has received the discharge stop command after the discharge circuit unit starts discharging the electric charge, switch whether to stop discharging the electric charge on the basis of a result monitored by the power supply monitoring unit.

### INCORPORATION BY REFERENCE

The disclosure of Japanese Patent Application No. 2012-263287 filed on Nov. 30, 2012 including the specification, drawings and abstract is incorporated herein by reference in its entirety.

### BACKGROUND OF THE INVENTION

1. Field of the Invention

The invention relates to a discharge control system and a discharge device. Particularly, the invention relates to a discharge control system and a discharge device configured to appropriately discharge electric charge stored in a capacitor and stop the discharging operation.

2. Description of Related Art

There is generally known a system that discharges electric charge stored in a capacitor (for example, see Japanese Patent Application Publication No. 2005-073399 (JP 2005-073399 A)). The system includes the capacitor and a discharge device. The capacitor smooths direct-current voltage applied to a power supply line as input voltage that is input to a motor inverter. The discharge device discharges electric charge stored in the capacitor. In this system, when a trigger signal that is issued at the time of issuance of a command to stop the operation of a motor is supplied from an external command device to the discharge device, a relay coil is energized only when electric charge remains in the capacitor. Thus, the discharge device discharges electric charge in the capacitor. Thus, at the time of issuance of a command to stop the operation of the motor, it is possible to discharge electric charge in the capacitor in accordance with a discharge command from the external command device to the discharge device.

However, in the system described in JP 2005-073399 A, the discharge device discharges electric charge in accordance with the discharge command from the external command device irrespective of the reliability of communication between the discharge device and the external command device. Alternatively, the discharge device stops discharging electric charge in accordance with a discharge stop command to stop discharging operation irrespective of the reliability of communication between the discharge device and the external command device. Thus, when the reliability of the communication is low, the discharge device may stop discharging electric charge in accordance with an erroneous command.

### SUMMARY OF THE INVENTION

The invention provides a discharge control system and a discharge device that are able to improve the reliability of a discharging process.

The first aspect of the invention is a discharge control system. The discharge control system includes a command unit, a first power supply, a discharge circuit unit, a power supply monitoring unit and a discharge stop control unit. The command unit is configured to issue a discharge command to discharge electric charge stored in a capacitor and a discharge stop command to stop discharging the electric charge stored in the capacitor. The first power supply is configured to supply electric power to the command unit. The discharge circuit unit is connected to the command unit via a communication line, the discharge circuit being configured to discharge the electric charge in accordance with the discharge command from the command unit and stop discharging the electric charge in accordance with the discharge stop command from the command unit. The power supply monitoring unit is configured to monitor a state of the first power supply. The discharge stop control unit is configured to, when the discharge circuit unit has received the discharge stop command from the command unit after the discharge circuit unit starts discharging the electric charge, switch whether to stop discharging the electric charge on the basis of a result monitored by the power supply monitoring unit.

The second aspect of the invention is a discharge device. The discharge device is connected via a communication line to a command unit that issues a discharge command to discharge electric charge stored in a capacitor and a discharge stop command to stop discharging the electric charge stored in the capacitor. The discharge device includes a power supply monitoring unit and a discharge stop control unit. The power supply monitoring unit is configured to monitor a state of a first power supply that supplies electric power to the command unit. The discharge stop control unit is configured to, when the discharge device has received the discharge stop command from the command unit after the discharge device starts discharging the electric charge in accordance with the discharge command from the command unit, switch whether to stop discharging the electric charge on the basis of a result monitored by the power supply monitoring unit.

According to the first and second aspects of the invention, after the discharge device starts discharging operation, only when the reliability of communication between the discharge device and the command unit is high, the discharge device accepts the discharge stop command from the command unit and stops the discharging operation in accordance with the discharge stop command. Thus, it is possible to improve the reliability of the discharging process.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall configuration view of an in-vehicle system in which a discharge control system according to an embodiment of the invention is installed;

FIG. 2A to FIG. 2C are examples of an operation time chart in the discharge control system according to the embodiment;

FIG. 3 is an example of a flowchart of a control routine that is executed by a discharge circuit in order to set a reliability decrease flag to an on state or an off state in the discharge control system according to the embodiment;

FIG. 4 is an example of a flowchart of a control routine that is executed by the discharge circuit in order to discharge electric charge in a smoothing capacitor and to stop the discharging operation in the discharge control system according to the embodiment; and

FIG. 5 is a relevant portion configuration view of a discharge control system according to an alternative embodiment of the invention.

### DETAILED DESCRIPTION OF EMBODIMENTS

Hereinafter, an example embodiment of a discharge control system according to the invention will be described with reference to the accompanying drawings.

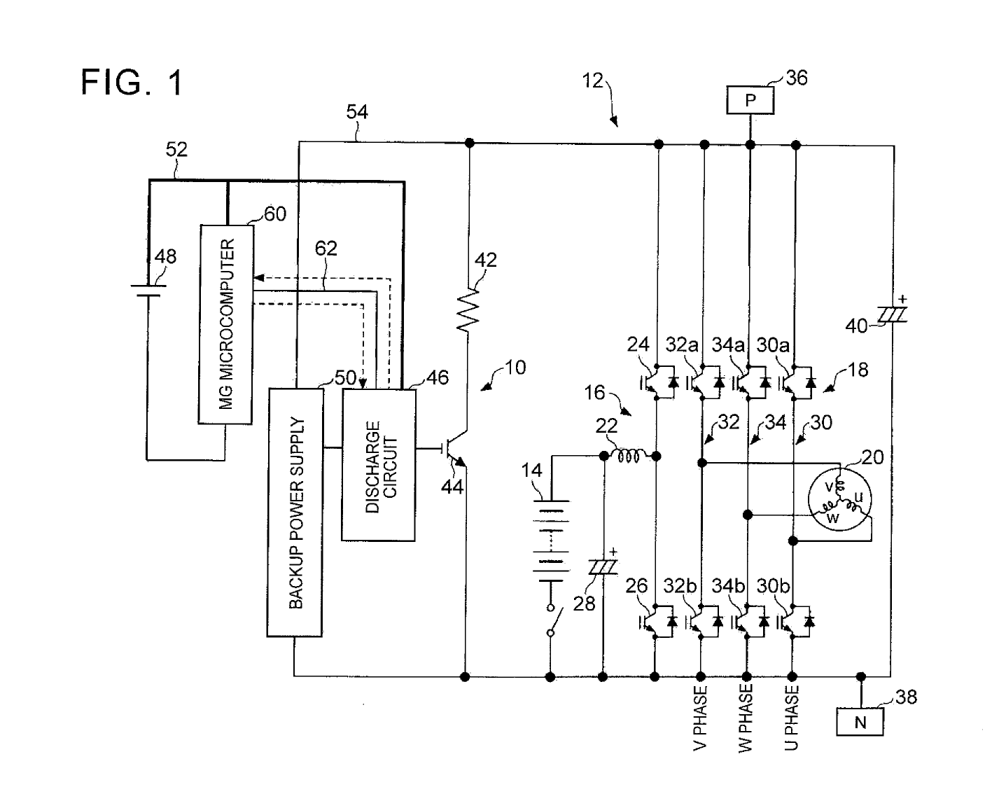

FIG. 1 shows the overall configuration view of an in-vehicle system 12 in which the discharge control system 10 according to the embodiment of the invention is installed. The in-vehicle system 12 is configured to step up the output voltage of a high-voltage battery 14 with the use of a step-up converter 16. The high-voltage battery 14 is mounted on a vehicle. The in-vehicle system 12 is configured to convert stepped-up direct-current power to alternating-current power with the use of an inverter 18 and supply the alternating-current power to a motor 20.

The motor 20 is a three-phase synchronous alternating-current motor, and has such a configuration that one ends of three U-phase, V-phase and W-phase coils are commonly connected to a neutral point. The motor 20 may be, for example, an electric motor that generates torque for driving drive wheels of an electric vehicle or hybrid vehicle. Alternatively, the motor 20 may be an electric motor that starts an engine as an electric motor used for a vehicle engine. The high-voltage battery 14 is a device that is able to store direct-current power, and is, for example, a lithium ion battery, a nickel metal hydride battery, or the like. For example, the high-voltage battery 14 may be able to supply electric power at an output voltage of about 300 volts.

The step-up converter 16 and the inverter 18 are interposed between the high-voltage battery 14 and the motor 20. The step-up converter 16 includes a coil 22, a pair of switching elements 24, 26 and a filter capacitor 28. The step-up converter 16 is a circuit configured to step up the output voltage (for example, about 300 volts) of the high-voltage battery 14 to a stepped-up voltage (for example, about 650 volts) through on/off operations of the pair of switching elements by utilizing the energy storage function of the coil 22. The step-up converter 16 just needs to be configured to perform step-up operation while the vehicle is traveling.

The inverter 18 is a device for generating alternating-current power to be supplied to the motor 20 using the direct-current power of the high-voltage battery 14, stepped up by the step-up converter 16. The inverter 18 has pairs of upper and lower aims 30, 32, 34 corresponding to the respective phases of the motor 20. The U-phase upper and lower arms 30, the V-phase upper and lower arms 32 and the W-phase upper and lower arms 34 are connected in parallel with one another between a positive electrode terminal (P) 36 and a negative electrode terminal (N) 38 between which the output voltage of the step-up converter 16 is applied.

The U-phase upper and lower arms 30 include a switching element 30a that is an upper arm element and a switching element 30b that is a lower arm element. The V-phase upper and lower arms 32 include a switching element 32a that is an upper arm element and a switching element 32b that is a lower arm element. The W-phase upper and lower arms 34 include a switching element 34a that is an upper arm element and a. switching element 34b that is a lower arm element. The upper arm element and lower aim element of each of the three-phase upper and lower arms 30, 32, 34 are connected in series with each other between the positive electrode terminal 36 and the negative electrode terminal 38. A midpoint between the upper arm element and lower arm element of each of the three-phase upper and lower arms 30, 32, 34 is connected to the other end of a corresponding one of the three-phase coils of the motor 20. Each of the switching elements is, for example, a power transistor, such as IGBT.

The inverter 18 is configured such that the upper arm element and lower arm element of each of the three-phase upper and lower arms 30, 32, 34 are alternately turned on or off. There is a phase shift of 120° in electric angle between the three phases. Thus, the inverter 18 is configured to convert direct-current voltage to alternating-current voltage and output the alternating-current voltage. The on/off state of each of the switching elements that are the upper arm element and the lower arm element is controlled by a control signal from a control device (not shown).

A smoothing capacitor 40 is interposed between the positive electrode terminal 36 and the negative electrode terminal 38. The smoothing capacitor 40 is a circuit that smooths direct-current voltage (specifically, stepped-up voltage stepped up by the step-up converter 16) between the positive electrode terminal 36 and the negative electrode terminal 38. The smoothing capacitor 40 is provided inside the inverter 18. The direct-current voltage smoothed by the smoothing capacitor 40 is applied between the positive electrode terminal 36 and the negative electrode terminal 38 as the input voltage of the inverter 18.

A discharge resistor 42 is connected in series with a discharging switching element 44 between the positive electrode terminal 36 and the negative electrode terminal 38. The discharge resistor 42 is a resistor for consuming electric charge stored in the smoothing capacitor 40 at the time when the electric charge is discharged. The discharging switching element 44 is a switch that is turned on at the time when electric charge stored in the smoothing capacitor 40 is discharged. The discharging switching element 44 is, for example, a power transistor, such as IGBT.

A discharge circuit 46 is electrically connected to the gate of the discharging switching element 44. The discharge circuit 46 is a circuit that discharges electric charge stored in the smoothing capacitor 40 by turning on the discharging switching element 44 or stops the discharging operation by turning off the discharging switching element 44. The discharge circuit 46 is incorporated in the inverter 18. The discharge circuit 46 is connected to an auxiliary battery 48 and a backup power supply 50. The auxiliary battery 48 is provided outside of the inverter 18 mounted on the vehicle. The backup power supply 50 is provided in the inverter 18. The discharge circuit 46 is able to operate on electric power that is selectively supplied from the auxiliary battery 48 or the backup power supply 50.

The auxiliary battery 48 is a device that is able to store direct-current power, and is, for example, able to supply electric power at the output voltage of about 12 volts. The backup power supply 50 is able to generate a desired voltage (for example, 20 volts) by stepping down the output voltage of the smoothing capacitor 40, that is, direct-current voltage between the positive electrode terminal 36 and the negative electrode terminal 38 and supply electric power. The auxiliary battery 48 and the backup power supply 50 are power supplies different from each other. The auxiliary battery 48 is connected to a low-voltage-system power supply line 52. The smoothing capacitor 40 inside the inverter 18 and the backup power supply 50 (that is, the positive electrode terminal 36) are connected to a high-voltage-system power supply line 54. The low-voltage-system power supply line 52 and the high-voltage-system power supply line 54 are electrically insulated from each other.

The in-vehicle system 12 includes a microcomputer (hereinafter, referred to as MG microcomputer) 60. The MG microcomputer 60 is provided outside the inverter 18. The MG microcomputer 60 executes drive control over the motor 20 and the inverter 18. The MG microcomputer 60 determines whether to discharge electric charge stored in the smoothing capacitor 40 in the event of a collision of the vehicle, or the like. After that, the MG microcomputer 60 determines whether to stop the discharging operation.

The MG microcomputer 60 is connected to the auxiliary battery 48 via the low-voltage-system power supply line 52, and is able to operate on electric power supplied from the auxiliary battery 48 through the low-voltage-system power supply line 52.

The MG microcomputer 60 is connected to the discharge circuit 46 via a communication line 62. The MG microcomputer 60 and the discharge circuit 46 are able to communicate with each other via the communication line 62. The MG microcomputer 60 issues a discharge command, which instructs the discharge circuit 46 to discharge electric charge in the smoothing capacitor 40, via the communication line 62 when the discharging operation should be performed. The MG microcomputer 60 issues a discharge stop command, which instructs the discharge circuit 46 to stop discharging electric charge in the smoothing capacitor 40, via the communication line 62 when the discharging operation should be stopped. The discharge circuit 46 turns on or off the discharging switching element 44 in accordance with a command from the MG microcomputer 60 via the communication line 62. Thus, the discharge circuit 46 discharges electric charge stored in the smoothing capacitor 40 or stops the discharging operation.

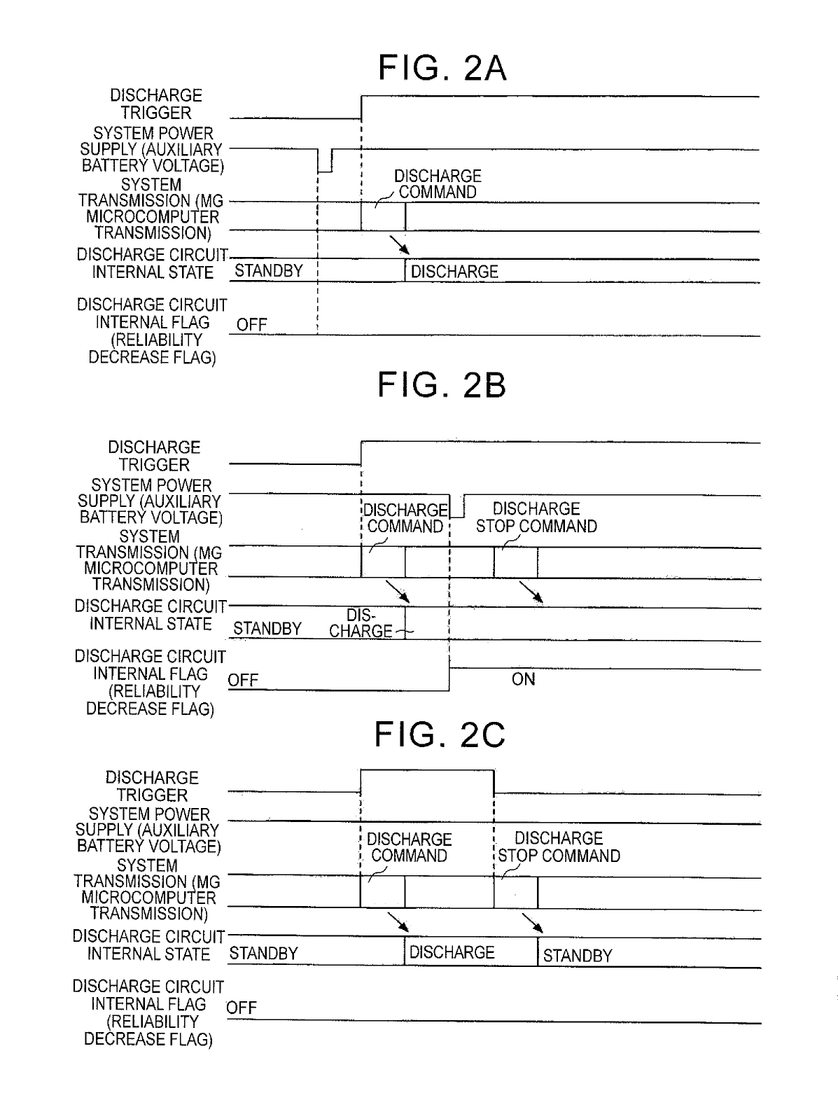

Next; operation in the discharge control system 10 according to the present embodiment will be described with reference to FIG. 2A to FIG. 4.

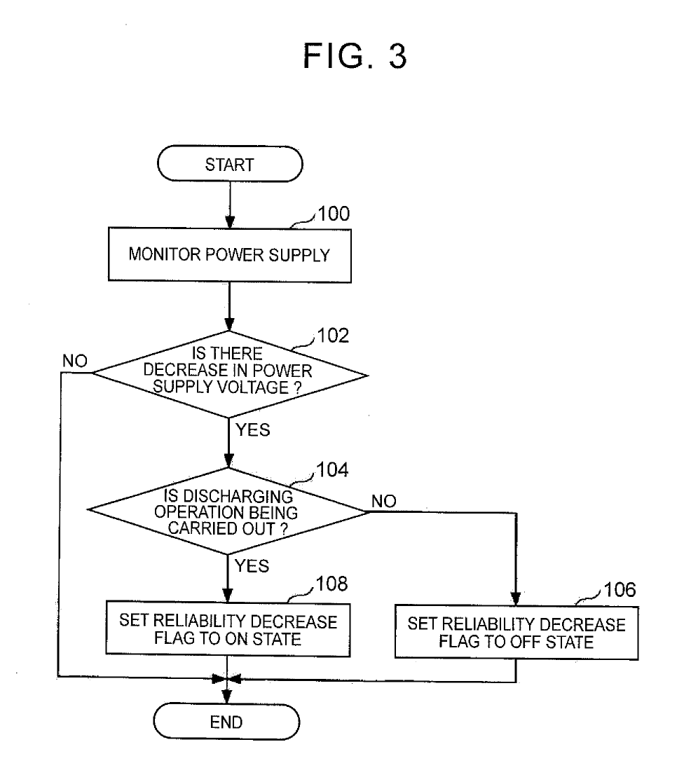

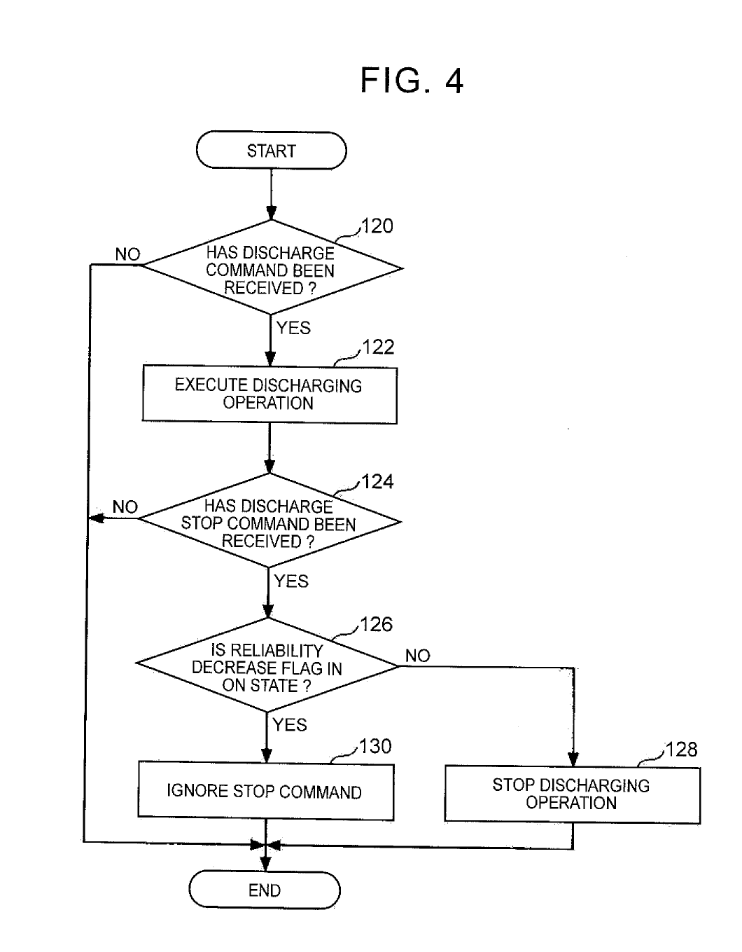

FIG. 2A to FIG. 2C show examples of an operation time chart in the discharge control system 10 according to the present embodiment. FIG. 3 shows an example of a flowchart that is executed by the discharge circuit 46 in order to set a reliability decrease flag to an on state or an off state in the discharge control system 10 according to the present embodiment. FIG. 4 shows an example of a flowchart of a control routine that is executed by the discharge circuit 46 in order to discharge electric charge in the smoothing capacitor 40 or stop the discharging operation in the discharge control system 10 according to the present embodiment.

In the discharge control system 10 according to the present embodiment, the MG microcomputer 60 is able to operate on electric power supplied from the auxiliary battery 48 via the low-voltage-system power supply line 52. In a situation in which electric power is supplied from the auxiliary battery 48 to the MG microcomputer 60, the MG microcomputer 60 determines whether to discharge electric charge stored in the smoothing capacitor 40 in the event of a collision of the vehicle, or the like (discharge determination). After discharge determination, the MG microcomputer 60 determines whether to stop the discharging operation (discharge stop determination). The MG microcomputer 60 issues a discharge command, which instructs the discharge circuit 46 to discharge electric charge in the smoothing capacitor 40, via the communication line 62 when the discharging operation should be performed. The MG microcomputer 60 issues a discharge stop command, which instructs the discharge circuit 46 to stop discharging electric charge in the smoothing capacitor 40, via the communication line 62 when the discharging operation should be stopped.

The above-described MG microcomputer 60 may determine whether a discharge condition is satisfied or whether a discharge stop condition is satisfied on the basis of information acquired by the MG microcomputer 60 by itself on its own accord.

Alternatively, the MG microcomputer 60 may determine whether the discharge condition is satisfied or whether the discharge stop condition is satisfied on the basis of, for example, a vehicle collision signal transmitted from an external upper-level device.

The discharge circuit 46 is able to operate on electric power selectively supplied from the auxiliary battery 48 or the backup power supply 50. The discharge circuit 46 is supplied with electric power from the auxiliary battery 48 via the low-voltage-system power supply line 52 in principle. On the other hand, the discharge circuit 46 is able to switch the power supply, from which electric power is supplied, from the auxiliary battery 48 to the backup power supply 50 when the input voltage from the auxiliary battery 48 has decreased to a predetermined value or below.

The discharge circuit 46 monitors the state of the auxiliary battery 48 (system power supply) on the basis of a voltage input from the low-voltage-system power supply line 52 connected thereto (step 100). Then, the discharge circuit 46 determines whether the input voltage (power supply voltage) from the auxiliary battery 48 has decreased to the predetermined value or below (step 102). The predetermined value is a maximum voltage at which the system power supply instantaneously interrupts due to, for example, a collision of the vehicle, and is a threshold voltage at which the system is reset.

When the discharge circuit 46 determines as a result of the process of step 102 that the power supply voltage for the auxiliary battery 48 exceeds the predetermined value, the discharge circuit 46 ends the current routine without proceeding to any process thereafter. In this case, the discharge circuit 46 maintains the state where the auxiliary battery 48 is used as the power supply from which electric power is supplied, and the operation of the discharge circuit 46 is maintained by the power supply voltage from the auxiliary battery 48.

On the other hand, when the discharge circuit 46 determines as a result of the process of step 102 that the power supply voltage for the auxiliary battery 48 has decreased to the predetermined value or below, the discharge circuit 46 proceeds with the process to step 104. In step 104, at the timing at which it is determined that the power supply voltage for the auxiliary battery 48 has decreased to the predetermined value or below, it is determined whether the discharging switching element 44 is turned on and electric charge stored in the smoothing capacitor 40 is being discharged. When the discharge circuit 46 determines as a result of the process of step 102 that the power supply voltage for the auxiliary battery 48 has decreased to the predetermined value or below, the discharge circuit 46 switches the power supply, from which electric power is supplied, from the auxiliary battery 48 to the backup power supply 50, and the operation of the discharge circuit 46 is maintained by the power supply voltage from the backup power supply 50. That is, the discharge circuit 46 switches the power supply, from which electric power is supplied, from the auxiliary battery 48 to the backup power supply 50 on the basis of the result of the process of step 102.

When the discharging switching element 44 is turned off and the discharge circuit 46 is not discharging electric charge in the smoothing capacitor 40 as a result of determination of step 104, the discharge circuit 46 sets the incorporated reliability decrease flag to the off state (step 106; see FIG. 2A). On the other hand, when the discharging switching element 44 is turned on and the discharge circuit 46 is discharging electric charge in the smoothing capacitor 40, the discharge circuit 46 sets the incorporated reliability decrease flag to the on state (step 108; see FIG. 2B).

The reliability decrease flag is a flag incorporated in the discharge circuit 46, and is a flag that indicates whether it is possible to ensure the reliability of communication through the communication line 62 between the MG microcomputer 60 and the discharge circuit 46 after the discharge circuit 46 starts discharging electric charge stored in the smoothing capacitor 40. The reliability decrease flag is set to the off state when the reliability of the communication is ensured, and is set to the on state when the reliability of the communication is not ensured.

In this way, in the present embodiment, in a situation in which the discharge circuit 46 is supplied with electric power from the auxiliary battery 48 or the backup power supply 50, the discharge circuit 46 is configured to monitor the state (power supply voltage) of the auxiliary battery 48. The discharge circuit 46 sets the reliability decrease flag to the off state when electric charge in the smoothing capacitor 40 is not being discharged at the time when the power supply voltage from the auxiliary battery 48 has decreased. On the other hand, the discharge circuit 46 is able to set the reliability decrease flag to the on state because the state of the auxiliary battery 48 is abnormal when electric charge in the smoothing capacitor 40 is being discharged at the time when the power supply voltage from the auxiliary battery 48 has decreased.

The discharge circuit 46 determines whether the discharge command transmitted from the MG microcomputer 60 via the communication line 62 has been received in a situation in which the discharge circuit 46 is being supplied with electric power from the auxiliary battery 48 or the backup power supply 50 (step 120). As a result, when the discharge circuit 46 determines that the discharge command has not been received from the MG microcomputer 60, the discharge circuit 46 ends the current routine without proceeding to any process thereafter. On the other hand, when the discharge circuit 46 determines that the discharge command has been received from the MG microcomputer 60, the discharge circuit 46 turns on the discharging switching element 44 in accordance with the discharge command (step 122). When the discharging switching element 44 is turned on, electric charge stored in the smoothing capacitor 40 is consumed by the discharge resistor 42. Thus, electric charge in the smoothing capacitor 40 is discharged.

Once the discharge circuit 46 turns on the discharging switching element 44, the discharge circuit 46 just needs to continue the on state of the discharging switching element 44 for a predetermined time-out period in principle and continue discharging electric charge in the smoothing capacitor 40 for the predetermined time-out period thereafter. The time-out period just needs to be set to a sufficient period of time during which electric charge in the smoothing capacitor 40 is completely discharged. For example, the time-out period may be set to 5 seconds.

The discharge circuit 46 discharges electric charge in the smoothing capacitor 40 by turning on the discharging switching element 44, and then determines whether the discharge stop command transmitted from the MG microcomputer 60 via the communication line 62 has been received (step 124). As a result, when the discharge circuit 46 determines that the discharge stop command has not been received from the MG microcomputer 60, the discharge circuit 46 ends the current routine without proceeding to any process thereafter. In this case, discharging electric charge in the smoothing capacitor 40 is continued. On the other hand, when the discharge circuit 46 determines that the discharge stop command has been received from the MG microcomputer 60, the discharge circuit 46 subsequently determines whether the incorporated reliability decrease flag is in the on state (step 126).

As a result, when it is determined that the reliability decrease flag is in the off state, the discharge circuit 46 understands that the state of the auxiliary battery 48 is normal after discharging the smoothing capacitor 40 is started, and determines that the reliability of communication via the communication line 62 between the MG microcomputer 60 and the discharge circuit 46 is ensured. Thus, the discharge circuit 46 switches the discharging switching element 44 from the on state to the off state in accordance with the discharge stop command from the MG microcomputer 60 received via the communication line 62 as described above (step 128). When the discharging switching element 44 is switched from the on state to the off state, one end side of the discharge resistor 42 is opened, so discharging electric charge stored in the smoothing capacitor 40 is stopped (see FIG. 2C).

On the other hand, when the discharge circuit 46 determines that the reliability decrease flag is in the on state, the discharge circuit 46 understands that the state of the auxiliary battery 48 is abnormal after discharging the smoothing capacitor 40 is started, and determines that the reliability of communication via the communication line 62 between the MG microcomputer 60 and the discharge circuit 46 is not ensured. Thus, the discharge circuit 46 does not switch the discharging switching element 44 from the on state to the off state in accordance with the discharge stop command received from the MG microcomputer 60 via the communication line 62 as described above (step 130). That is, the discharge circuit 46 ignores the discharge stop command, and discharging electric charge in the smoothing capacitor 40 is continued (see FIG. 2B).

In this way, in the present embodiment, when the discharge circuit 46 has received the discharge stop command to stop discharging electric charge in the smoothing capacitor 40 from the MG microcomputer 60 after discharging the electric charge is started, the discharge circuit 46 is able to switch whether to stop discharging electric charge in the smoothing capacitor 40 on the basis of whether the reliability decrease flag is in the on state at the timing of the reception. Specifically, when the reliability decrease flag is in the off state, the discharge circuit 46 is able to stop discharging electric charge in the smoothing capacitor 40; whereas, when the reliability decrease flag is in the on state, the discharge circuit 46 is able to continue discharging electric charge in the smoothing capacitor 40 by not stopping discharging the electric charge.

That is, in the present embodiment, the discharge circuit 46 monitors the power supply voltage of the auxiliary battery 48 that supplies electric power to the MG microcomputer 60 after the discharge circuit 46 starts discharging electric charge in the smoothing capacitor 40. Then, when the discharge circuit 46 has received the discharge stop command for stopping discharging the electric charge from the MG microcomputer 60, the discharge circuit 46 is able to switch whether to stop discharging electric charge in the smoothing capacitor 40 in accordance with the discharge stop command on the basis of the monitored result.

The discharge circuit 46 starts discharging the smoothing capacitor 40 due to, for example, a collision of the vehicle. When the system is reset due to the fact that the power supply voltage of the auxiliary battery 48 has decreased to the predetermined value or below in a period from when discharging the smoothing capacitor 40 is started to when the discharge stop command transmitted from the MG microcomputer 60 via the communication line 62 is received, unintended communication is highly likely to be carried out from the MG microcomputer 60 to the discharge circuit 46 via the communication line 62 due to, for example, a collision of the vehicle. That is, the MG microcomputer 60 is highly likely to unintentionally issue the discharge stop command to the discharge circuit 46 via the communication line 62. Therefore, in the present embodiment, when the power supply voltage has decreased to the predetermined value or below and the discharging operation is being carried out, the discharge circuit 46 sets the reliability decrease flag to the on state because the reliability of communication via the communication line 62 has decreased. After that, the discharge circuit 46 ignores the discharge stop command transmitted from the MG microcomputer 60 to the discharge circuit 46 via the communication line 62. That is, the discharge circuit 46 continues discharging electric charge in the smoothing capacitor 40. In this case, discharging electric charge in the smoothing capacitor 40 is continued for the predetermined time-out period, and, after that, the discharging operation is ended.

On the other hand, when the power supply voltage of the auxiliary battery 48 has not decreased to the predetermined value or below in a period from when discharging the smoothing capacitor 40 is started to when the discharge circuit 46 receives the discharge stop command transmitted from the MG microcomputer 60 via the communication line 62, and the system is not reset, unintended communication is less likely to be carried out from the MG microcomputer 60 to the discharge circuit 46 via the communication line 62 due to, for example, a collision of the vehicle. Therefore, in the present embodiment, in such a case, the discharge circuit 46 sets the reliability decrease flag to the o ff state because the reliability of communication via the communication line 62 is high. After that, the discharge circuit 46 stops discharging electric charge in the smoothing. capacitor 40 in accordance with the discharge stop command transmitted from the MG microcomputer 60 to the discharge circuit 46 via the communication line 62.

As described above, in the discharge control system 10 according to the present embodiment, the discharge circuit 46 starts discharging the smoothing capacitor 40 in accordance with the discharge command from the MG microcomputer 60 based on, for example, a collision of the vehicle. The discharge circuit 46 is able to operate on electric power supplied from the backup power supply 50. After discharging the smoothing capacitor 40 is started, the discharge circuit 46 monitors the power supply voltage of the auxiliary battery 48. Then, the discharge circuit 46 determines the reliability of communication between the discharge circuit 46 and the MG microcomputer 60 on the basis of the monitored result. When the reliability of communication between the discharge circuit 46 and the MG microcomputer 60 is maintained in a high state, the discharge circuit 46 accepts the discharge stop command from the MG microcomputer 60; and stops discharging the smoothing capacitor 40 in accordance with the discharge stop command. On the other hand, when the reliability of communication between the discharge circuit 46 and the MG microcomputer 60 is maintained in a low state, the discharge circuit 46 ignores the discharge stop command from the MG microcomputer 60, and continues discharging the smoothing capacitor 40.

Therefore, according to the present embodiment, in order to cause the discharge circuit 46 to execute the process of discharging electric charge in the smoothing capacitor 40 in accordance with the communication command from the MG microcomputer 60 to the discharge circuit 46 via the communication line 62, it is possible to improve the reliability of the discharging process.

For example, even when the MG microcomputer 60 erroneously and unintentionally issues the discharge command to the discharge circuit 46 and then the discharge circuit 46 starts discharging the smoothing capacitor 40 in accordance with the discharge command, but when the power supply voltage of the auxiliary battery 48 is normal thereafter, it is possible to cause the discharge circuit 46 to forcibly stop discharging the smoothing capacitor 40 by transmitting the discharge stop command from the MG microcomputer 60 to the discharge circuit 46 via the communication line 62. Even when the discharge circuit 46 erroneously starts discharging the smoothing capacitor 40 although there is no discharge command from the MG microcomputer 60 while the vehicle is traveling, for example, the MG microcomputer 60 is caused to detect unintentional discharge by detecting the discharge current, and the MG microcomputer 60 is caused to transmit the discharge stop command to the discharge circuit 46 at the time when the unintentional discharge has been detected. Thus, it is possible to cause the discharge circuit 46 to forcibly stop discharging the smoothing capacitor 40. In this respect, according to the present embodiment, even when unintentional and erroneous discharge of the smoothing capacitor 40 is started, it is possible to avoid wasteful discharge of electric charge in the smoothing capacitor 40.

When the discharge circuit 46 starts discharging the smoothing capacitor 40 in accordance with the discharge command from the MG microcomputer 60 based on, for example, a collision of the vehicle, but when the power supply voltage of the auxiliary battery 48 is abnormal thereafter, the discharge circuit 46 determines that the discharge stop command transmitted from the MG microcomputer 60 to the discharge circuit 46 via the communication line 62 is highly likely to be issued due to, for example, a collision of the vehicle, so it is possible to ignore the discharge stop command. Thus, the discharge circuit 46 is able to continue discharging the smoothing capacitor 40. In this respect, according to the present embodiment, even when the discharge stop command is erroneously issued due to, for example, a collision of the vehicle after discharging the smoothing capacitor 40 is started, it is possible to reliably discharge electric charge in the smoothing capacitor 40, and it is possible to complete discharging operation of the smoothing capacitor 40.

Furthermore, in the present embodiment, the discharge circuit 46 is able to operate on electric power supplied from the backup power supply 50 together with electric power supplied from the auxiliary battery 48 that supplies electric power to the MG microcomputer 60. The power supply voltage of the backup power supply 50 is generated from the output voltage of the smoothing capacitor 40, that is, direct-current voltage between the positive electrode terminal 36 and the negative electrode terminal 38, and is a voltage applied to the high-voltage-system power supply line 54 in the inverter 18 that is insulated from the low-voltage-system power supply line 52 to which the auxiliary battery 48 is connected.

Therefore, according to the present embodiment, even when the low-voltage-system power supply line 52 outside the inverter 18 receives damage due to, for example, a collision of the vehicle and then the system power supply voltage (the power supply voltage of the auxiliary battery 48) has decreased after discharging the smoothing capacitor 40 is started, it is possible to cause the discharge circuit 46 to continue discharging the smoothing capacitor 40 in accordance with the discharge stop command transmitted from the MG microcomputer 60 to the discharge circuit 46 via the communication line 62.

In the above-described embodiment, the MG microcomputer 60 may be regarded as “command unit” according to the invention. The auxiliary battery 48 may be regarded as “first power supply” according to the invention. The discharge circuit 46 may be regarded as “discharge circuit unit” and “discharge device” according to the invention. The backup power supply 50 may be regarded as “second power supply” according to the invention. The operation that the discharge circuit 46 monitors the output voltage of the auxiliary battery 48, that is, the voltage of the low-voltage-system power supply line 52, may be regarded as “power supply monitoring unit” according to the invention. The operation that the discharge circuit 46 executes the processes of step 102 to step 108 in the routine shown in FIG. 3 and the processes of step 124 to step 130 in the routine shown in FIG. 4 may be regarded as “discharge stop control unit” according to the invention. The operation that the discharge circuit 46 switches the power supply, from which electric power is supplied, between the auxiliary battery 48 and the backup power supply 50 on the basis of the output voltage of the auxiliary battery 48, that is, the monitored result of the voltage of the low-voltage-system power supply line 52, may be regarded as “power supply switching unit” according to the invention.

Incidentally, in the above-described embodiment, electric charge stored in the smoothing capacitor 40 is consumed by the discharge resistor 42 in order to discharge the smoothing capacitor 40. On the other hand, when the smoothing capacitor 40 is discharged, a switching element, such as MOS and IGBT, may be set to a half-on state, and electric charge stored in the smoothing capacitor 40 may be consumed by the switching element. At this time, the gate voltage of the switching element may be set to near a threshold, and the switching element may be short-circuited while flowing current is limited.

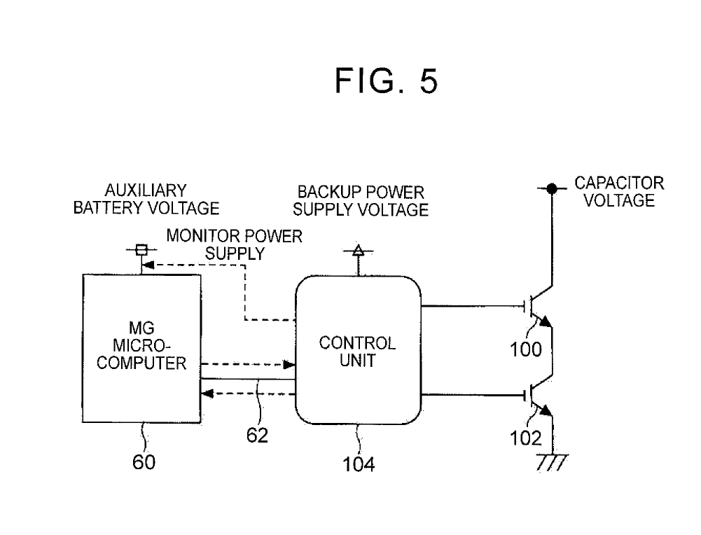

In the above-described embodiment, the discharge circuit 46 that controls discharging of electric charge in the smoothing capacitor 40 is exclusively provided; however, the embodiment of the invention is not limited to this configuration. For example, as shown in FIG. 5, a control unit 104 that controls switching operations of switching elements 100, 102 (specifically, 30a, 30b, 32a, 32b, 34a, 34b) that are a pair of serially connected upper arm element and lower arm element of the inverter 18 connected to both ends of the smoothing capacitor 40 may also serve as a discharge circuit that controls discharging of electric charge in the smoothing capacitor 40. In this case, the control unit 104 is caused to monitor the state of the auxiliary battery 48, and, when the smoothing capacitor 40 is discharged, one of the switching elements 100, 102 is set to a half-on state and the other one of the switching elements 100, 102 is set to a fully on state. Thus, electric charge stored in the smoothing capacitor 40 just needs to be consumed by the half-on one of the switching elements 100, 102. However, the control unit 104 needs to be configured to operate as a backup power supply that supplies electric power by generating a desired voltage (for example, 20 volts) by stepping down the output voltage of the smoothing capacitor 40, that is, direct-current voltage between the positive electrode terminal 36 and the negative electrode terminal 38.

In the above-described embodiment, the discharge circuit 46 monitors the output voltage of the auxiliary battery 48, that is, the voltage of the low-voltage-system power supply line 52, and switches whether to switch the power supply and to stop the discharging operation in accordance with the discharge stop command on the basis of the monitored result of the voltage. On the other hand, the embodiment of the invention is not limited to this configuration. A voltage monitoring IC that monitors the output voltage of the auxiliary battery 48, that is, the voltage of the low-voltage-system power supply line 52, may be provided other than the discharge circuit 46, and the discharge circuit 46 may switch whether to switch the power supply and stop the discharging operation in accordance with the discharge stop command on the basis of the monitored result of the voltage from the voltage monitoring IC.

Furthermore, in the above-described embodiment, the discharge control system 10 is applied to the in-vehicle system 12 mounted on the vehicle; however, the embodiment of the invention is not limited to this configuration. The discharge control system 10 may be applied to a system other than the in-vehicle system 12.

What is claimed is:

1. A discharge control system comprising:
a command unit configured to issue a discharge command to discharge electric charge stored in a capacitor and a discharge stop command to stop discharging the electric charge stored in the capacitor;
a first power supply configured to supply electric power to the command unit;
a discharge circuit unit connected to the command unit via a communication line, the discharge circuit being configured to discharge the electric charge in accordance with the discharge command from the command unit and stop discharging the electric charge in accordance with the discharge stop command from the command unit;
a power supply monitoring unit configured to monitor a state of the first power supply; and
a discharge stop control unit configured to, when the discharge circuit unit has received the discharge stop command from the command unit after the discharge circuit unit starts discharging the electric charge, switch whether to stop discharging the electric charge on the basis of a result monitored by the power supply monitoring unit.

2. The discharge control system according to claim 1, wherein
the discharge stop control unit is configured to, when the state of the first power supply, monitored by the power supply monitoring unit, is normal after the discharge circuit unit starts discharging the electric charge, stop discharging the electric charge on the basis of the discharge stop command, and
the discharge stop control unit is configured to, when the state of the first power supply, monitored by the power supply monitoring unit, is abnormal after the discharge device starts discharging the electric charge, continue discharging the electric charge stored in the capacitor.

3. The discharge control system according to claim 1, further comprising:
a second power supply configured to generate voltage using the electric charge stored in the capacitor and configured to supply electric power to the discharge circuit unit.

4. The discharge control system according to claim 3, further comprising:
a power supply switching unit configured to switch a power supply, which supplies electric power to the discharge circuit unit, between the first power supply and the second power supply on the basis of the result monitored by the power supply monitoring unit.

5. The discharge control system according to claim 1, wherein
the power supply monitoring unit and the discharge stop control unit are provided in the discharge circuit unit.

6. The discharge control system according to claim 1, wherein
the power supply monitoring unit is configured to monitor voltage of the first power supply, and
the discharge stop control unit is configured to determine whether the voltage has decreased to a predetermined value or below and, when the discharge stop control unit determines that the voltage has decreased to the predetermined value or below, stop discharging the electric charge.

7. The discharge control system according to claim 6, wherein
the predetermined value is a threshold voltage at which the discharge control system is reset.

8. The discharge control system according to claim 1, wherein
the discharge circuit unit includes a switching element, and is configured to discharge the electric charge or stop discharging the electric charge by switching a state of the switching element between an on state and an off state.

9. A discharge device connected via a communication line to a command unit that issues a discharge command to discharge electric charge stored in a capacitor and a discharge stop command to stop discharging the electric charge stored in the capacitor, the discharge device comprising:
a power supply monitoring unit configured to monitor a state of a first power supply that supplies electric .power to the command unit; and
a discharge stop control unit configured to, when the discharge device has received the discharge stop command from the command unit after the discharge device starts discharging the electric charge in accordance with the discharge command from the command unit, switch whether to stop discharging the electric charge on the basis of a result monitored by the power supply monitoring unit.

10. The discharge device according to claim 9, wherein
the discharge stop control unit is configured to, when the state of the first power supply, monitored by the power supply monitoring unit, is normal after discharging the electric charge is started in accordance with the discharge command from the command unit, stop discharging the electric charge on the basis of the discharge stop command, and
the discharge stop control unit is configured to, when the state of the first power supply, monitored by the power supply monitoring unit, is abnormal, continue discharging the electric charge stored in the capacitor.

11. The discharge device according to claim 9, further comprising:
a power supply switching unit configured to switch a power supply, from which electric power is supplied, between the first power supply and a second power supply on the basis of the result monitored by the power supply monitoring unit,
the second power supply is configured to generate voltage using the electric charge stored in the capacitor.

12. The discharge device according to claim 9, wherein
the power supply monitoring unit is configured to monitor voltage of the first power supply, and
the discharge stop control unit is configured to determine whether the voltage has decreased to a predetermined value or below and, when the discharge stop control unit determines that the voltage has decreased to the predetermined value or below, stop discharging the electric charge.

13. The discharge device according to claim 12, wherein
the predetermined value is a threshold voltage at which the discharge device is reset.
